(19) United States
(12) Patent Application Publication
(10) Pub. No.: US 2012/0079501 A1
(43) Pub. Date: Mar. 29, 2012

(54) Application Load Adaptive Processing Resource Allocation

(76) Inventor: Mark Henrik Sandstrom, (US)

(21) Appl. No.: 13/184,028

(22) Filed: Jul. 15, 2011

Related U.S. Application Data
(60) Provisional application No. 61/386,801, filed on Sep. 27, 2010.
(60) Provisional application No. 61/417,259, filed on Nov. 25, 2010.
(60) Provisional application No. 61/476,268, filed on Apr. 16, 2011.

(51) Int. Cl. G06F 9/46

(52) U.S. Cl. 718/105

(57) ABSTRACT

The invention provides hardware-automated systems and methods for efficiently sharing a multi-core data processing system among a number of application software programs, by dynamically reallocating processing cores of the system among the application programs in an application processing load adaptive manner. The invention enables maximizing the whole system data processing throughput, while providing deterministic minimum system access levels for each of the applications. With invented techniques, each application on a shared multi-core computing system dynamically gets a maximized number of cores that it can utilize in parallel, so long as all applications on the system still get at least up to their entitled number of cores whenever their actual processing load so demands. The invention provides inherent security and isolation between applications, as each application resides in its dedicated system memory segments, and can safely use the shared processing system as if it was the sole application running on it.

### CROSS-REFERENCE TO RELATED APPLICATIONS

This application claims the benefit of the following, each of which is incorporated by reference in its entirety:
[1] U.S. Provisional Application No. 61/386,801, filed Sep. 27, 2010;
[2] U.S. Provisional Application No. 61/417,259, filed Nov. 25, 2010; and
[3] U.S. Provisional Application No. 61/476,268, filed Apr. 16, 2011.
   This application is also related to the following, each of which is incorporated by reference in its entirety:
[4] U.S. Utility application Ser. No. 12/869,955, filed Aug. 27, 2010; and
[5] U.S. Utility application Ser. No. 12/982,826, filed Dec. 30, 2010.

### BACKGROUND

1. Technical Field

This invention pertains to the field of digital data processing systems, particularly to the field of optimizing processing throughput of a data processing system through application program load adaptive allocation of processing resources among the application programs sharing the system.

2. Descriptions of the Related Art

Traditionally, computing performance optimizations have fallen into two categories. First, in the field conventionally referred to as high performance computing, the main objective has been maximizing the processing speed of one given computationally intensive program running on a dedicated hardware comprising a number of parallel processing elements. Second, in the field conventionally referred to as utility computing, the main objective has been to most efficiently share a given pool of computing hardware resources among a large number of user application programs. Thus, in effect, one branch of the computing efficiency effort has been seeking to effectively use a large number of parallel processors to accelerate execution of a single application program, while another branch of the effort has been seeking to have a large number of user applications to share a single pool of computing capacity to improve the utilization of the computing resources.

However, there have not been any major synergies between these two efforts; often, pursuing any one of these traditional objectives rather happens at the expense of the other. For instance, it is clear that a practice of dedicating an entire parallel processor based (super) computer per individual application causes severely sub-optimal computing resource utilization, as much of the capacity would be idling much of the time. On the other hand, seeking to improve utilization of shared data processing systems by sharing or oversubscribing their processing capacity among a number of user applications will cause non-deterministic and compromised performance for the individual applications, along with security concerns.

As such, the overall cost-efficiency of computing is not improving as much as any nominal improvements toward either of the two traditional objectives would imply: traditionally, single application performance maximization comes at the expense of system utilization efficiency, while overall system efficiency maximization comes at the expense of performance of by the individual application programs.

Moreover, even outside traditional high performance computing, the application program performance requirements will increasingly be exceeding the processing throughput achievable from a single central processing unit (CPU) core, e.g. due to the practical limits being reached on the CPU clock rates.

There thus exists a need for inventions, which, at the same time, enable increasing the speed of executing application programs, including through execution of a given application in parallel across multiple processor cores, as well improving the utilization of the data processing resources available, thereby maximizing the collective application processing throughput for a given cost budget.

### SUMMARY

The invention enables a set of data processing application programs to efficiently execute on a shared processing hardware comprising multiple processing engines such as CPUs, or time-share abstractions of them, e.g. virtual machines, collectively herein referred to as cores. Hardware logic automated systems and methods according to the invention allow any given application among the set to execute in parallel on multiple, and up to all of the, cores on a given shared processing system, while said systems and methods are also able provide e.g. a contract-based deterministic minimum system access level (e.g. in terms of time units of CPU cores used) for any given application whenever the application actually has data processing load available to utilize such amount of the system processing core capacity. The invented data processing system thereby is able to dynamically optimize the allocation of its parallel processing capacity among a number of concurrently running software applications, in a manner that is adaptive to realtime processing loads offered by the applications, without having to use any of the processing capacity of the multi-core system for any non-user system software overhead functions.

The invention provides a data processing system comprising an array of processing cores, which are dynamically shared by a set of software application programs configured to run on the system in an application program processing load adaptive manner. In an embodiment of the invention, such an application program load adaptive data processing system comprises: an array of processing cores for processing instructions and data of a set of application programs configured to place-and-time share the system; and a placer module for repeatedly assigning individual cores of the array to individual application programs among said set. Moreover, in a certain embodiment of such a system, the assigning function by the placer uses as one if its inputs indicators by the application programs of said set expressing how many cores of the array each given program is presently demanding for processing of its tasks. Also, in embodiments of the invention, the placer module is implemented in digital hardware logic within the system.

The invention also provides a process for concurrently, in an application load adaptive manner, executing a set of software application programs in a digital data processing system comprising an array of processing cores. An embodiment of such a process comprises a series of steps including: a) by each of the application program, maintaining at a specified address within a memory space of the home-core of the application within the system a capacity demand indicator to be used in allocating the array of cores of the system among the set of programs; b) by a placer module within the system, repeatedly allocating the array of cores among the set of programs at least in part based on the capacity demand indicators of the set of programs; and c) by the cores of system, processing instructions and data of the set of programs to produce processing results, wherein which program of the set is assigned for processing by which core or cores of the array is determined based at least in part on the allocating per step b).

The invention further provides an algorithm for mapping, a set of software application programs to execute on an array of processing cores of a shared data processing hardware. According to an embodiment of the invention, such an algorithm comprises repeatedly exercised steps as follows: a) monitoring capacity demand indicators of the set of application programs expressing on how many cores among the array of cores each given program is a currently able to execute; b) allocating the array of cores among the set of programs at least in part based on said capacity demand indicators; and c) controlling which program among the set will execute on which core among the array at least in part based on allocating the array of cores according to step b).

Embodiments of the invention also involve a method for assigning optimal sets of core instances of a data processing system comprising an array of processing cores to each program among a set of software application programs running on the shared system. According to a particular embodiment, such an assignment method, exercised each time after the cores of the system are allocated among the programs on the system anew, comprises the following steps: (i) first, within the array, the home-core of any given program is assigned to its associated program for each program of the set that was allocated at least one core; (ii) following step (i), iterating through the set of programs, for each given program, until a number of cores assigned to the given program has reached either of a number of cores allocated to it or its entitled quota of cores, available cores closest to the home-core of the given program are assigned to that given program; and (iii) following exercising of step (ii) for the set of programs, iterating through the set of programs, for each given program, until a number of cores assigned to the given program has reached the number of cores allocated to it, available cores closest to the home-core of the program are assigned to the given program.

Embodiments of the invention further involve a method for optimally placing processing tasks of a set of software application programs into processing cores of a data processing system comprising an array of processing cores. In a certain embodiment, where each given program among said has a number of selected tasks equal to a number of cores of the array allocated to the given program and presents its selected tasks as a priority ordered list, the method comprises the following steps: (i) first, the highest priority selected task of each given program with at least one selected task is placed to a home-core of its program within the array of cores; (ii) following step (i), iterating through the set of programs, any unplaced tasks of a given program, until a number of placed tasks for the given program would exceed an entitled quota of cores for the given program, are placed in their reducing priority order to available cores within the array closest to the home-core of the given program; and (iii) following exercising of step (ii) for the set of programs, iterating through the set of programs, any remaining unplaced tasks of a given program are assigned in their reducing priority order to available cores within the array closest to the home-core of the given program.

Accordingly, the invention enables each software application on a shared multi-core computing system to dynamically get a maximized number of processing cores that it can utilize in parallel so long as such demand-driven core allocation allows all applications on the system to get at least up to their entitled number of cores whenever their processing load actually so demands. The invention thereby facilitates efficiently sharing a multi-core data processing system hardware among a number of application software programs, maximizing the whole system data processing throughput, while providing deterministic minimum processing throughput levels for each of the applications configured to run on the system.

There furthermore is inherent security and isolation between the individual processing applications in systems according to the invention, as each application resides in its dedicated segments within the system memories, and can safely use the shared processing system as if it was the sole application running on it. This includes that a given application program for systems according to the invention can be developed and tested largely with similar relative low complexity and high productivity as in the (practically often cost prohibitive) case that the entire multi-core system per the invention was dedicated for them; the application programs for systems per the invention need to be only minimally aware of each others or of the underlying hardware automated application and task to core placing and context switching mechanisms. The hardware based security of systems and methods according to the invention can be used to disallow any undesired interactions between the applications and tasks on the system already at the hardware level, and thereby eliminate or significantly reduce the need for conventional, complex techniques for dealing with inter-application security threads at software layers.

### BRIEF DESCRIPTION OF THE DRAWINGS

FIG. 1 shows, in accordance with an embodiment of the invention, a functional block diagram for an application program load adaptive parallel data processing system, comprising an array or processing cores, dynamically space and time shared among a set of application software programs.

FIG. 2 provides a context diagram for a process, implemented on the system of FIG. 1, to select and map the active tasks of application programs configured to run on the system to their target processing cores, in accordance with an embodiment of the invention.

FIG. 3 illustrates, in accordance with an embodiment of the invention, the flow diagram and major steps for the process of FIG. 2.

FIG. 4 depicts in greater detail the step of the process of FIG. 3 to switch the active context for the processing cores of the system of FIG. 1, following exercising of system core capacity allocation, assignment and application task to core mapping algorithms of the process of FIG. 3, in accordance with an embodiment of the invention.

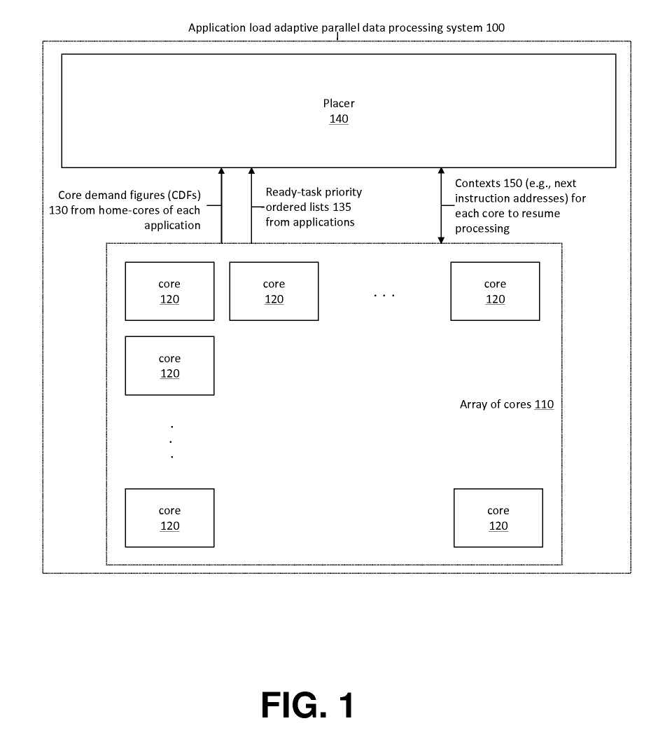

The following symbols and notations used in the drawings:
Boxes indicate a functional module, e.g., a process step, or a logic subsystem such as a digital look-up-table (LUT).
A dotted line box indicates a group of elements forming a logical entity, e.g. the hierarchical module 110 in FIG. 1.
Arrows indicate a data signal flow. A signal flow may comprise one or more parallel bit wires.
Arrows ending into or beginning from a bus represent joining or disjoining of a sub-flow of data or control signals into or from the bus, respectively.
Lines and arrows between nodes in the drawings represent a logical communication path, and may consist of one or more physical wires. The direction of arrow does not preclude communication in also the opposite direction, as the directions of the arrows are drawn to indicate the primary direction of information flow with reference to the below description of the drawings.
   The figures depict embodiments of the invention for purposes of illustration only. One skilled in the art will readily recognize from the following discussion that alternative embodiments of the structures and methods illustrated herein may be employed without departing from the inventive principles presented herein.

### DETAILED DESCRIPTION

The invention is described herein in further detail by illustrating the novel concepts with reference to the drawings.

FIG. 1 provides a functional block diagram for an embodiment of the invented multi-core data processing system, with application program processing load adaptive allocation of the cores among the software applications configured for the system. For general context, the system of FIG. 1 comprises an array 110 of processing cores 120 for processing instructions and data of a set of software application programs configured run on to shared the system. In such manner processing the application programs to produce processing results and outputs, the cores of the system access their input and output data arrays, which in embodiments of the invention comprise memories accessible to one or more of the cores, as well as input and output communication ports accessible to one or more of the cores. Since the present invention is directed primarily to the techniques to dynamically sharing the processing cores of the system among its application programs rather than on implementation details of the cores themselves or those of their memory and networking facilities, aspects such as memories and communication ports of the cores, though normally present within the embodiments of the multi-core data processing system 100, are not shown in FIG. 1. Moreover, it shall be understood that in various embodiments, any of the cores 120 of a system 100 can be any types of program processing hardware resources, e.g. central processing units, graphics processing units, digital signal processors or application specific processors etc. Embodiments of systems 100 can furthermore incorporate CPUs etc. processing cores that are not part of the dynamically allocated array 110 of cores, and such CPUs etc. outside the array 110 can be used to manage and configure e.g. system-wide aspects of the entire system 100, including the placer module 140 of the system and the array 110.

As illustrated in FIG. 1, an embodiment of the invention provides a data processing system 100 comprising an array 110 of processing cores 120, which are shared by a set of application programs configured to run on the system. In the embodiments studied herein in detail, each application program is assigned a memory segment within the memory space of each core 120 in the system, as well as a home-core within the system. The individual application programs running on the system maintain at specified addresses within the system 100 memory space their processing capacity demand indicators signaling 130 to the placer 140 a level of demand of the system processing capacity by the such applications. In an embodiment, these indicators 130, referred to herein as core-demand-figures (CDFs), express how many cores 120 their associated application program is presently able utilize for its data processing tasks. Moreover, in certain embodiments, the individual applications maintain their CDFs at specified hardware device registers within the system, e.g. in a known addresses within the memory space of their home-cores, with such application CDF device registers being accessible by the placer hardware logic 140. For instance, in an embodiment, the CDF 130 of a given application program is a function of the number of its schedulable tasks, such as processes, threads or functions (called collectively as tasks) that are ready to execute at a given time. In a particular embodiment of the invention, CDF of an application program expresses on how many processing cores the program is presently able to execute in parallel. Moreover, in certain embodiments, these capacity demand indicators, for any given application, include a list 135 identifying its ready tasks in a priority order.

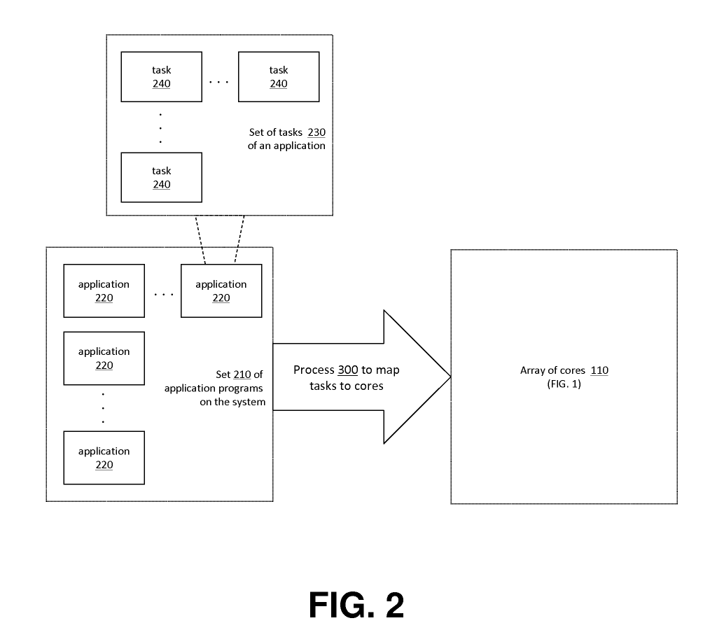

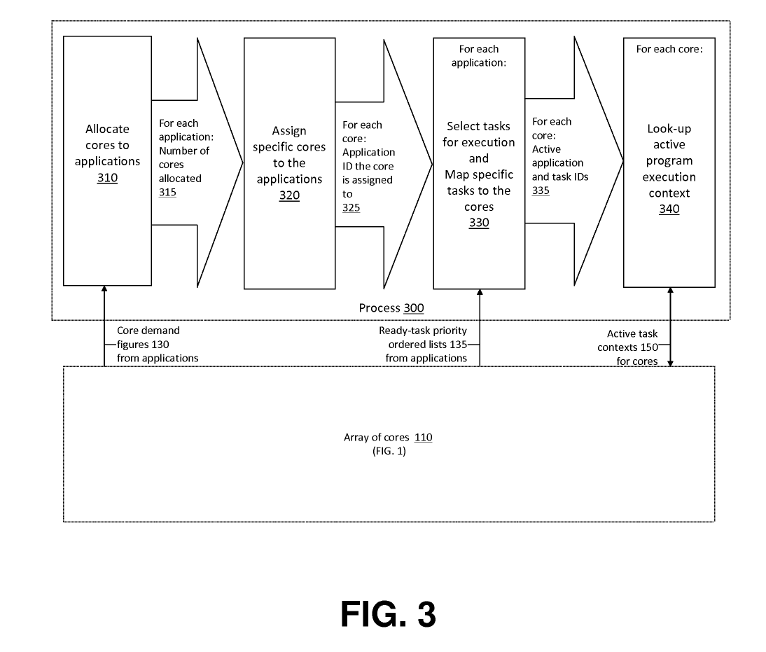

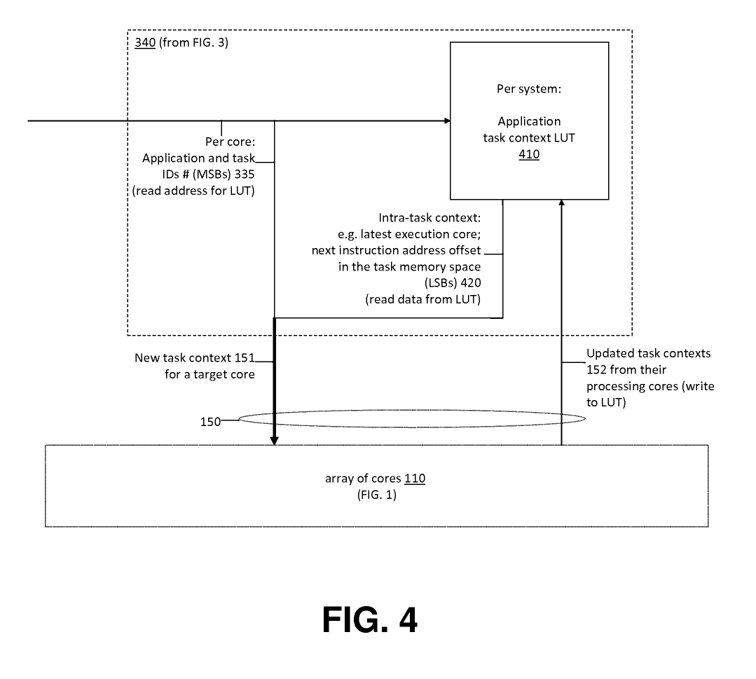

A hardware logic based placer module 140 within the system, through a repeating process, allocates and assigns the cores 120 of the system 100 among the set of applications and their tasks, at least in part based on the CDFs 130 of the applications. In certain embodiments, this application task to core placement process 300 (see FIGS. 2 and 3) is exercised periodically, e.g. at even intervals such as once per a given number (for instance 64, or 1024, or so forth) of processing core clock or instruction cycles. In other embodiments, this process 300 can be run e.g. based on a change in the CDFs 130 of the applications 220. Though not explicitly shown in FIG. 1, embodiments of the system 100 also involve timing and synchronization control information flows between the placer 140 and the core fabric 110 to signal events such as launching and completion of the process 300 (FIGS. 2-4) by the placer as well as to inform about the progress of the process 300 e.g. in terms of advancing of its steps (FIGS. 3-4). Also, in embodiments of the invention, the placer module is implemented by digital hardware logic within the system, and in particular embodiments, such placer modules operate their repeating algorithms, including those of process 300 per FIGS. 2-4, without software involvement.

FIG. 2 illustrates the context of the process 300 performed by the placer logic 140 of the system 100, repeatedly mapping the to-be-executing tasks 240 of the set of application programs 210 to their target cores 120 within the array 110. In an embodiment, each individual application 220 configured for a system 100 provides an updating collection 230 of tasks 240, even though for clarity of illustration in FIG. 2 this set of applications tasks is drawn only for one of the applications within the set 210. Note that the terms software application program, application program, application and program are used interchangeably in this specification, and each generally refer to any type of computer software able to run on data processing systems according to any embodiments of the invention. Note further that in certain embodiments, any application program 220 for a system 100 can be an operating system (OS) for a given user of the system 100, with such user OS supporting a number of applications of its own, and in such scenarios the OS client 220 on the system 100 can present such applications of it to the placer 140 of the system as its tasks 240.

In the general context of FIGS. 1 and 2, FIG. 3 provides a conceptual data flow diagram for an embodiment of the process 300, which maps each selected-to-execute application task 240 within the sets 230 to its assigned target core 120 within the array 110.

FIG. 3 presents, according to an embodiment of the invention, the conceptual major phases of the task-to-core mapping process 300, used for maximizing the application program processing throughput of a data processing system hardware shared among a number of software programs. Such process 300, repeatedly mapping the to-be executing tasks of a set of applications to the array of processing cores within the system, involves a following series of steps:
(1) allocating 310 the array of cores among the set of programs on the system, at least in part based on CDFs 130 by the programs, to produce for each program a number of cores allocated to it 315 (for the time period in between the current and the next run of the process 300);
(2) based at least in part on step (1), assigning 320 specific core instances to individual programs, to produce, for each given core of the array, an identification of the program that the given core was assigned to 325;
(3) based at least in part on step (2), for each given application that was assigned at least one core: (a) identifying 135 a number of tasks within the application selected for execution corresponding to the number of cores allocated to the given application and (b) mapping 330 each selected task to one of the cores assigned to the application, to produce, for each core of the array, an identification of an application and a task within the application that the given core was assigned to 335; and
(4) based at least in part on the mapping 330, maintaining in a look-up-table and retrieving from it 340 appropriate application task contexts 150 for the cores of the array to resume program processing.

FIG. 4 provides a view of an embodiment of a logic module for the context switching phase 340 of the process 300 at level of further detail.

Internal functions of the context look-up step 340 of the process 300 presented in FIG. 4 involve a look-up-table (LUT) 410 to read out the intra-task execution context 420 for the target processing core 120 for which the given instance of the step 340 is being exercised. The intra-task context (e.g. its program counter value, etc.) 420 are logically combined with the IDs 335 of the application and task assigned to the given target core 120, to form a complete context 151 for the core to resume its processing. Moreover, the updated task execution contexts 152 are written by (or retrieved by logic at module 340 from) their processing cores 120 back to the LUT 410. Note that in various embodiments, the steps and modules of the process 300 can be implemented using various combinations of software and hardware logic, and for instance, various memory management techniques can be used to pass (series of) pointers to the actual memories where the updated elements of the task context are kept, rather than passing directly the actual context, etc.

### Module-Level Implementation Specifications for the Application Task to Core Placement Process:

Details of embodiments of the steps of the process 300 (FIG. 3) are described in the following. In an embodiment of the invention, the process 300 is implemented by hardware logic in the placer module 140 of the system in FIG. 1.

Objectives for the core allocation algorithm 310 include maximizing the system core utilization (i.e., minimizing core idling so long as there are ready tasks), while ensuring that each application gets at least up to its entitled (e.g. a contract based minimum) share of the system core capacity whenever it has processing load to utilize such amount of cores. In the embodiment considered herein regarding the system capacity allocation optimization methods, all cores 120 of the array 110 are allocated on each run of the related algorithms 300. Moreover, let us assume that each application configured for the given multi-core system 100 has been specified its entitled quota of the cores, at least which quantity of cores it is to be allocated whenever it is able to execute on such number of cores in parallel; typically, sum of the applications' entitled quotas is not to exceed the total number of cores in the system. More precisely, according to the herein studied embodiment of the allocation algorithm 310, each application program on the system gets from each run of the algorithm:
(1) at least the lesser of its (a) entitled quota and (b) Core Demand Figure (CDF) worth of the cores (and in case (a) and (b) are equal, the ‘lesser’ shall mean either of them, e.g. (a)); plus
(2) as much beyond that to match its CDF as is possible without violating condition (1) for any application on the system; plus
(3) the application's even division share of any cores remaining unallocated after conditions (1) and (2) are satisfied for all applications sharing the system.
   In an embodiment of the invention, the cores 120 to application programs 220 allocation algorithm 310 is implemented per the following specifications:
(i) First, any CDFs 135 by any application programs up to their entitled share of the cores within the array 110 are met. E.g., if a given program #M had its CDF worth zero cores and entitlement for four cores, it will be allocated zero cores by this step (i). As another example, if a given program #N had its CDF worth five cores and entitlement for one core, it will be allocated one core by this stage of the algorithm 310.
(ii) Following step (i), any processing cores remaining unallocated are allocated, one core per program at a time, among the application programs whose demand 135 for processing cores had not been met by the amounts of cores so far allocated to them by preceding iterations of this step (ii) within the given run of the algorithm 310. For instance, if after step (i) there remained eight unallocated cores and the sum of unmet portions of the program CDFs was six cores, the program #N, based on the results of step (i) per above, will be allocated four more cores by this step (ii) to match its CDF.
(iii) Following step (iii), any processing cores still remaining unallocated are allocated among the application programs evenly, one core per program at time, until all the cores of the array 110 are allocated among the set of programs 210. Continuing the example case from steps (i) and (ii) above, this step (iii) will be allocating the remaining two cores to certain two of the programs. In particular embodiments, the programs with zero existing allocated cores, e.g. program #M from step (i), the are prioritized in allocating the remaining cores at the step (iii) stage of the algorithm 310.
   Moreover, in a certain embodiments, the iterations of steps (ii) and (iii) per above are started from a revolving application program within the set 210, e.g. so that the application ID # to be served first by these iterations is incremented by one (and returning to the ID #0) for each successive run of the process 300 and the algorithm 310 as part of it. Moreover, embodiments of the invention include a feature by which the algorithm 310 allocates for each application program, regardless of the CDFs, at least one core once in a specified number (e.g. sixteen) of process 300 runs, to ensure that the each application will be able to keep at least its CDF 135 input to the process 300 updated.

According to descriptions and examples above, the allocating of the array of cores 110 according to the embodiments of the algorithm 310 studies herein in detail is done in order to minimize the greatest amount of unmet demands for cores (i.e. greatest difference between the CDF and allocated number of cores for any given application 220) among the set of programs, while ensuring that any given program gets at least its entitled share of the processing cores following such runs of the algorithm for which it demanded 130 at least such entitled share of the cores.

Once the set of cores 110 are allocated 310 among the set of applications 210, specific core 120 instances are assigned 320 to each application 220 that were allocated one or more cores on the given core allocation algorithm run 310. In an embodiment, one schedulable 240 task is assigned per one core 120. Objectives for the application-to-core placement algorithm 330 include minimizing the total volume of tasks to be moved between cores, while keeping the first active task (referred to as task #0, e.g., a root process or equal) of each given application at the home-core of the given application. In certain embodiments of the invention, the system placer 140 assigns the set of cores (which set can be zero at times for any given application) for each application, and further processes for each application will determine how any given application utilizes the set of cores being allocated to it. In other embodiments, such as those studied herein in further detail, the system placer 140 also assigns a specific application task to each core.

To study details of an embodiment of the placement algorithm 330, let us consider the cores of the system to be identified as core #0 through core #(N−1), wherein N is the total number of pooled cores in a given system 100. For simplicity and clarity of the description, we will from hereon consider an example system under study with a relatively small number N of sixteen cores. We further assume a scenario of relatively small number of also sixteen application programs configured to run on that system, with these applications identified for the purpose of the description herein alphabetically, as application #A through application #P. With such example assumptions, cores 120 as they were allocated between the applications by a given run of the allocation algorithm are assigned 320 to specific applications 220 by the placer 140 in the following manner, according to an embodiment of the invention:
i) First, the home-core is assigned to its associated application program for each program that was allocated at least one core.
ii) Following step i), iterating through the set of programs 210, for each given program 220, until a number of cores assigned to the given program has reached a lesser (incl. equal) of (a) a number of cores allocated to and (b) entitled quota of cores for the given program, available cores closest to the home-core of the program are assigned to it. E.g., if the home-core of a program was the core #4, and that program got allocated three of its assumed four entitled cores, it will be assigned the cores #4, #5 and #6.
iii) Following exercising of step ii) for the set of programs, iterating again through this set of programs, for each given program, until a number of cores assigned to the given program has reached the number of cores allocated to it, available cores closest to the home-core of the program are assigned to it. E.g., if an application's entitled quota was one core, its home the core #8, it was allocated three cores, and—after steps i) and ii), as well as the step iii) for applications alphabetically before it, are completed—the next cores up from #8 remaining unassigned were cores #14 and #1, it will be assigned the cores #8, #14 and #1.
   Regarding the above specification of an embodiment of the assignment algorithm 320, note that exercising of this algorithm does not impact the number of cores that any given application program gets; this number is provided as a result of the allocation step 310. For this reason, the number of allocated cores yet to be assigned to any given program at step iii) per above will remain available for assignment to that given application at that stage of the algorithm, since steps i) and ii) did not affect the overall core to application allocation within the system.

Following the assignment 320 of the cores among the applications, for each active application on the system (that were allocated one or more cores by the latest run of the core allocation algorithm 310), the individual ready-to-execute tasks 240 are selected and mapped 330 to the cores assigned to the given application. In an embodiment, each application maintains a priority ordered list (see element 135 in FIG. 3) of its ready to execute tasks, and following any given run of the core-to-application assignment algorithm 320, assuming that a given application was assigned P (a positive integer) cores, the P highest priority ready tasks of the application are mapped 330 to the P cores assigned to the application. In case the application had less than P ready tasks, the highest priority other (e.g. waiting, not ready) tasks are mapped to the cores beyond the cores for which the ready tasks of the application were mapped to; these other tasks can thus directly begin executing on their mapped cores once they become ready. Moreover, in a particular embodiment, the launching (root) task of the application gets mapped 330 to its application's home-core whenever it is ready to execute, and the remaining selected tasks (if any) are mapped to the cores assigned to the application in their priority order with ascending distance of the cores from the home-core, i.e., with the Q^{th} highest priority task outside the home-core being mapped to the Q^{th} closest one of the cores assigned to the application as measured from the home-core. Possible measures of the distance include the difference between the core IDs, and the number of cores in between the assigned core and the home-core of the application within a core array matrix 110, wherein both the cores along the rows and columns of the matrix (and additional dimensions for real or virtual multi-dimensional core arrays) between said end-point cores are summed up to, in embodiments with varying scaling factors for different dimensions and core-hops within the matrix or array 110, to compute this distance measure.

In further embodiments, mapping 330 of tasks to cores involves further criteria and objectives, such as keeping more closely related (collaborating) tasks mapped to cores closer (or with better inter-core communication capabilities) to each other in the matrix 110, and/or minimizing the volume of task relocations between cores.

It is noted that, according to the embodiments of the invention as described herein, the core assignments for any application up to its entitled quota will fall on a constant and contiguous range (referred to as the home-range of the application) starting from the home-core (e.g. an application with entitlement for up to four cores and home-core #8, will have its cores up to four assigned constantly to cores #8-11). As such, as long as a given application keeps its CDF mostly within its entitled quota, it largely can avoid relocations of its tasks between cores, in particular to and from outside its home-range. Moreover, embodiments of the system provide a reserved segment within each core's memory for each application configured for the system. Such per-application-dedicated segments can be pre-populated with the program code of their associated application tasks, in order to enable any task of any application to quickly execute on any of the system cores, even outside the home-range of the given application. Furthermore, to speed up execution of the programs at their assigned target cores, in embodiments of the invention, the memory segment dedicated to the task that got mapped to execute on a given core is copied to a fast-access memory (cache) of that core.

The production 340 of the active application task context 151 is illustrated by a conceptual logic diagram in FIG. 4 for a given example target core 120 within the matrix 110. The basic procedures, shown in FIG. 4 for one task 240 being enabled for execution at its assigned core, are in the full system 100 implemented (either in fully parallel or at least partly in a time-interleaved manner) for all the application tasks selected to execute on the system 100 following a run of the algorithm 330. According to an embodiment of the invention, to cause the appropriate processing core to receive its intended context instance among the active application task execution contexts produced by step 340, each such instance of contexts 151 is provided to the core array 110 with an indication of its associated target core ID #. In an alternative embodiment, the active application task contexts 151 are read from the placer 140 by the individual cores 120 in the system (in a certain implementation scenario, in parallel), without a need for explicit identification of target core for each task context entry as each core directly reads its next context from the LUT 410 (following an indication of completion of a mapping process 330). Such core-driven parallel context read embodiments further provide a core-to-task mapping LUT (at element 330 in FIG. 3, at least conceptually) for the cores to read their next application and task IDs 335, with which the cores then retrieve their next intra-task contexts 420 from the application-task-indexed LUT 410 shown in FIG. 4. In all such implementation scenarios, where the algorithms 300 map one of the selected application tasks to execute on each processing core of the fabric 110, each core of the system 100 gets thus assigned a unique task to process following successive runs of these algorithms.

Per FIG. 4, the task processing contexts 420, e.g. the next instruction address and the ID of the latest executing core, of the tasks of each application are maintained in (at least conceptually, in a system wide) LUT 410 addressed with application and task IDs. The information 420 from LUT 410 regarding the latest processing core for the given task 240 is to be used, depending on whether the next processing core for that task is different than the latest (or, whether the next task for a core is different than its latest), in determining whether or how to migrate any further necessary data and processing context stored locally at the latest processing core's memories into the next core's memories. To form the full (conceptual) address bus value 151 for a given target processor, the system combines the task-level context 420 (e.g. address of next instruction) as the (conceptual) least significant bits (LSBs), the task ID # bits as the next upper bits, and the application ID # as the (conceptual) most significant bits (MSBs) 335 of the (conceptual) bit vector 151. In effect, by prepending the target core ID # to such core-level context 150, a full system 100 scope address for the given task context is formed. Noting that the reference to core address bus MSBs and LSBs herein is conceptual, please see also reference [5], paragraph 0026, second and third bullet points. It shall be understood that in various embodiments, the conceptual MSBs and LSBs, with their operational significance per description herein, can be mapped to various address bus bit positions for the memories of any given core.

### Summary of Process Flow and Information Formats Produced and Consumed by Main Stages of the Application Task to Core Placement Process:

The production of updated task contents 151 (in FIG. 4, part of 150 in FIGS. 1 and 3) for the processing cores 120 of the system 100 by the process 300 (FIG. 3, implemented by placer 140 in FIG. 1) from the Core Demand Figures (CDFs) 130 of the applications 220 (FIG. 2), as detailed above with module level implementation examples, thus proceeds through the following stages and intermediate results (in reference to FIG. 3), according to an embodiment of the invention:
(a) Each application 220 produces its CDF 130, e.g. an integer between 0 and the number of cores within the array 110 expressing on how many concurrently executable tasks 240 the application presently has ready to execute. A possible implementation for the information format 130 is such that logic in the placer module periodically samples the CDF bits from the home core of each application for the core allocation module 310 and forms an application ID-indexed table (per Table 1 below) as a ‘snapshot’ of the application CDFs to launch the process 300. A conceptual example of the format of the information 130 is provided in Table 1 below—note however that in the hardware logic implementation, the application ID index, e.g. for range A through P, is represented by a digital number, e.g., in range 0 through 15, and as such, the application ID # serves as the index for the CDF entries of this array, eliminating the need to actually store any representation of the application ID for the table providing information 130:

TABLE 1

| Application ID index | CDF value |
|---|---|
| A | 0 |
| B | 12 |
| C | 3 |
| . . . | . . . |
| P | 1 |

Regarding Table 1 above, note that the values of entries shown are simply examples of possible values of some of the application CDFs, and that the CDF values of the applications can change arbitrarily for each new run of the process 300 and its algorithm 310 using the snapshot of CDFs.
(b) Based at least in part on the application ID # indexed CDF array 130 per Table 1 above, the core allocation algorithm 310 of the process 300 produces another similarly formatted application ID indexed table, whose entries 315 at this stage are the number of cores allocated to each application on the system, as shown in Table 2 below:

TABLE 2

| Application ID index | Number of cores allocated |
|---|---|
| A | 0 |
| B | 6 |
| C | 3 |
| . . . | . . . |
| P | 1 |

Regarding Table 2 above, note again that the values of entries shown are simply examples of possible number cores of allocated to some of the applications after a given run on the algorithm 310, as well as that in hardware logic this array 315 can be simply the numbers of cores allocated per application, as the application ID for any given entry of this array is given by the index # of the given entry in the array 315.
(c) Based at least in part on the application ID # indexed allocated core count array 315 per Table 2 above, the core to application assignment algorithm 320 produces a core ID # indexed array 325 expressing to which application ID each given core of the fabric 110 got assigned, as illustrated in Table 3 below:

TABLE 3

| Core ID index | Application ID# |
|---|---|
| 0 | P |
| 1 | B |
| 2 | B |
| . . . | . . . |
| 15 | N |

Regarding Table 3 above, note that the symbolic application IDs (A through P) used here for clarity will in digital logic implementation map into numeric representations, e.g. in the range from 0 through 15. Also, the notes per Tables 1 and 2 above regarding the implicit indexing (i.e., core IDs for any given application ID entry are given by the index of the given entry, eliminating the need to store the core IDs in this array) apply for the logic implementation of Table 3 as well.
(d) The application task selection sub-process of mapping algorithm 330 uses as one of its inputs application specific priority ordered lists 135 of the ready task IDs of the applications; each such application specific list has the (descending) task priority level as their index, and the task ID # as the values stored at such indexed element, as shown in Table 4 below—notes regarding implicit indexing and non-specific examples used for values per Table 1-3 apply also for Table 4:

TABLE 4

| Task priority index # | Task ID # (points to start address of |
|---|---|
| application internal (lower index | the task-specific sub-range within |
| value signifies more urgent task- | the per-application dedicated |
| only ready tasks included) | memory space of the cores) |
| 0 | 0 |
| 1 | 8 |
| 2 | 5 |
| . . . | . . . |
| 15 | 2 |

In an embodiment, each application 220 maintains an array 135 per Table 4 at specified address at its home core, from where logic at module 330 retrieves this information to be used as an input for the task to core mapping algorithm 330.
(e) The application task to processing core mapping sub-process of the algorithm 330 uses information 315 and 135 per Tables 3 and 4 respectively, to produce a core ID indexed array 335 of the application and task IDs that the core # of the given index got assigned to, per Table 5 below:

TABLE 5

| | | Task ID (within the |
|---|---|---|
| | | application of column to the |
| Core ID index | Application ID | left) |
| 0 | P | 0 |
| 1 | B | 0 |
| 2 | B | 8 |
| . . . | . . . | . . . |
| 15 | N | 1 |

Comparing Tables 3 and Table 5, it is seen that Table 5 (element 335 in FIG. 3) is formed from Table 3 (element 325 in FIG. 3) by the algorithm 330 by appending the active task IDs for each of the application ID entries of Table 3. In hardware logic implementation the application and the intra-application task IDs of Table 5 can be bitfields of same digital entry at any given index of the array 335; the application ID bits can be the MSBs and the task ID bits the LSBs, and together these, in at least one embodiment, form the start address of the active application task's address range in a memory space of the target core identified by the index of the given entry of array 335 (illustrated in Table 5). Notes regarding implicit indexing and non-specific example entry values per preceding Tables apply also for Table 5.
(f) To produce the eventual output from placer module 140 back to core fabric 110, i.e., the (next) active task contexts 151 (FIG. 4, part of information flow 150 in FIGS. 1 and 3) for the individual cores, the module 340 further complements the information 335 (Table 5) by appending the updated processing context 420 for each active application task entry in the array 335 (Table 5), as shown in Table 6 below—notes regarding implicit indexing and non-specific example entry values per preceding Tables apply also for Table 6:

TABLE 6

| | | | Processing context |
|---|---|---|---|
| | | Task ID (within the | (of the application task |
| Core ID | | application of | of columns to left-in |
| index | Application ID | column to the left) | hexadecimal) |
| 0 | P | 0 | F 51 AD40 |
| 1 | B | 0 | 1 E0 0000 |
| 2 | B | 8 | 2 1B CB24 |
| . . . | . . . | . . . | . . . |
| 15 | N | 1 | F A0 92C0 |

From Table 6, for any given core ID indexed entry, the application and task IDs and the task processing context bitfields from three rightmost column entries of Table 6 (and in particular, the task-level next instruction address part of the processing context bitfield) can be combined to form the complete core-level context 151 for the given target core of the fabric 110, i.e. the full address for the core to resume application processing. In addition, in certain embodiments, the latest processing core of the given task (which can be the same as the next core for that task) is identified as part of the task processing context 420 (the rightmost column of Table 6), to facilitate transferring the updated processing results and data (e.g. fast access memory contents) to the next processing core of the task from its latest processing core. In an alternative embodiment, the tasks, before completion of the each run of the process 300, backup their updated processing memories to the home core of the application, from where the tasks, when resuming processing at different core than their latest one, retrieve the updated processing memory contents. Further embodiments still provide hardware automated mechanisms to update each task's memory segment at each core of the fabric 100 before the completion of the process 300, to ensure that any application task can readily resume processing at any core of the system that is got placed by any run of the process 300. Various other embodiments can implement various subsets, combinations and variations of these techniques. In a certain embodiment, the system-scope module 340 both obtains 152 the latest task processing context (pointers) from the cores of the system before the completion of the process 300 (specifically, before appending the task level context 420 to the core level context 151), as well as provides 151 the new task processing contexts for the cores of the system. In alternative embodiments, either core or application specific processes can be initiating participants in either or both of these functions (information flows 152 and 151 in FIG. 4).
(g) Note that the task processing context for the format of the entries 151 (the rightmost column of Table 6) are retrieved from the application-task ID indexed LUT 410 of FIG. 4 by providing the application and task IDs 335 (the third and second rightmost columns in the format of Table 6) as the read address; similarly, the cores write the updated task processing contexts to the LUT 410 using their active application and task IDs (in an embodiment, the MSBs of their present active address space specifying the instruction address range of their current active task) as the LUT write address. As such, LUT 410 in the herein studied embodiments is indexed with the application and task IDs, and provides as its contents the latest processing core ID and task processing context, per Table 7 below—notes regarding implicit indexing and non-specific example content values per preceding Tables apply also for Table 7:

TABLE 7

| | Task ID (within the | | |
|---|---|---|---|
| | application of | | |
| Application ID | column to the left)- | Latest processing | Task processing |
| MSBs of index | LSBs of index | core ID | context (hex) |
| A | 0 | 0 | 07 D100 |
| A | 1 | 0 | 91 4000 |
| . . . | . . . | | |
| A | 15 | 3 | 08 10C0 |
| B | 0 | 1 | 30 E0F0 |
| B | 1 | 1 | 91 4000 |
| . . . | . . . | | . . . |
| B | 15 | 7 | 08 10C0 |
| C | 0 | 2 | 20 0004 |
| . . . | . . . | . . . | . . . |
| P | 0 | 15 | 91 4000 |
| . . . | . . . | | |
| P | 15 | 2 | 08 10C0 |

Descriptions for example embodiments of LUT mechanisms applicable for the above description of the placer 140 modules are provided in the reference [5], e.g., at its paragraphs 0022-23 and 0038-40. In general, much of the logic system implementation and operation descriptions in [5], though primarily directed to examples of time-sharing a processing core among a number of application programs, can be applied, with appropriate modifications for the present purpose where necessary, for implementations for the logic system for the present invention that is directed to allocation 310 and assignment 320 of cores among a set of applications, and consequently mapping 330, 340 of application tasks to these cores. Since the process 300 executes repeatedly (and in certain embodiments periodically), the present invention can cause time sharing (even if at slower frequency than in [5]) of cores among tasks of the same or different ones among the applications configured to time-and-space share the multi-core system 100 in a manner logic-wise analogous with the cycle-by-cycle time division multiplexing of the CPU among the applications in [5] (noting that, in certain embodiments of the system 100, all applications reside at all cores, in their application-specific memory segments). As such, the time division logic operation of the data processing system capacity allocation optimization as described in [5] is largely applicable to present invention, which performs capacity allocation spatially, across a number of cores, as well as over time. Moreover, in certain scenarios, the application load adaptive allocation of parallel cores among processing applications according to the invention can be used in connection with the application or task load adaptive allocation of processor core time (e.g. instruction execution cycles) according to the reference [5]. If desiring to maintain a single-dimensional view of the capacity pool, the spatial dimension of capacity allocation can be conceptualized as a further level of granularity of system time slicing. With such conceptual approach, in effect, the spatial dimension of N parallel cores in the shared system can be viewed as multiplying each system time unit in the pool of units to be allocated among the applications by a factor of N. Beyond the addition of the spatial dimension to capacity allocation and application-task to core assignments, similar basic logic mechanisms of sharing any given core in the system along the time axis can be applied for systems per [5] and those utilizing the present invention.

Use-Case Scenarios and Benefits Arising from the Invention

According to the foregoing, the invention allows efficiently sharing a multi-core based computing hardware among a number of application software programs, maximizing the whole system data processing throughput, while providing deterministic minimum processing throughput levels for each one of the applications configured to run on the given system.

Besides having the algorithm that allocates the system cores among the applications to ensure that each given application gets at least up to the lesser of its CDF and its (e.g. contract based) entitled quota worth of cores on each application run of the algorithm, in certain embodiments of the invention, the applications are given credits based on their CDFs (as used by allocation algorithm runs) that were less than their entitlements. For instance, a user application can be given discounts on its utility computing contract as a function of how much less the application's average CDFs on contract periods (e.g., a day) were compared to the application's contract based entitlement of system's core capacity.

As an example, if a user applications' average CDFs were p % (p=0 to 100) less than the application's contract-based minimum system core access entitlement, the user can be given a discount of e.g. 0.25-times-p % its contract price for the period in question. Further embodiments can vary this discount factor D (0.25 in above example) depending on the average busyness of the applications on the system during the discount assessment period (e.g. one hour period of the contract) in question, varying for instance in the range from 0.1 to 0.9.

Moreover, the utility computing system operator can offer client computing capacity service contracts with non-uniform discount factor D time profiles, e.g., in a manner to make the contract pricing more attractive to specific type of customer applications with predictable busyness time profiles, and consequently seek to combine contracts 220 with non-overlapping D profile peaks (time periods with high discount factor) into shared compute hardware 100, 110 capacity pools. Such arrangement can lead both to improving the revenues from the compute hardware capacity pool to the utility computing service provider, as well improving the application program performance and throughput volume achieved for each of the customers running their applications 220 on the shared multi-core system 100. Generally, offering contracts to the users sharing the system so that the peaks of the D profiles are minimally overlapping can facilitate spreading the user application processing loads more evenly over time, and thus lead to maximizing both the system utilization efficiency as well as the performance (per given cost budget) experienced by each individual user application sharing the system.

In further embodiments, the contract price (e.g. for an entitlement up to four of the sixteen cores in the system whenever the application so demands) can vary from one contract pricing period to another e.g. on hourly basis (to reflect the relative expected or average busyness of the contract billing periods during a contract term), while in such scenarios the discount factor can remain constant.

Generally, goals for such discounting methods can include providing incentives for the users of the system to balance their application processing loads for the system more evenly over periods of time such as hours within a day, and days within a week, month etc. (i.e., seeking to avoid both periods of system overload as well as system under-utilization), and providing a greater volume of surplus cores within the system (i.e. cores that applications could have demanded within their entitlements, but some of which did not demand for a given run of the allocation algorithm) that can be allocated in a fully demand adaptive manner among those of the applications that can actually utilize such cores beyond their entitled quota of cores, for more parallelized execution of their tasks. Note that, according to these embodiments, the cores that an application gets allocated to it beyond its entitlement do not cost the user anything extra.

Accordingly, the system of FIG. 1 (and as further detailed in FIGS. 2-4 and related descriptions), in particular when combined with pricing discount factor techniques per above enables maximizing the overall utility computing cost-efficiency.

The invention thus enables each application program to dynamically get a maximized number of cores that it can utilize in parallel so long as such demand-driven core allocation allows all applications on the system to get at least up to their entitled number of cores whenever their processing load actually so demands.

It is further seen that the invented data processing system is able to dynamically optimize the allocation of its parallel processing capacity among a number of concurrently running processing applications, in a manner that is adaptive to realtime processing loads offered by the applications, without having to use any of the processing capacity of the multi-core system for any non-user (system) software overhead functions.

Accordingly, a listing of benefits of the invented, application load adaptive, operating system overhead free multi-user data processing system includes:
All the application processing time of all the cores across the system is made available to the user applications, as there is no need for a common system software to run on the system (e.g. to perform in the cores traditional operating system tasks such as time tick processing, serving interrupts, scheduling and placing applications and their tasks to the cores, and managing the context-switching between the running programs).
The application programs do not experience any considerable delays in ever waiting access to their (e.g. contract-based) entitled share of the system's processing capacity, as any number of the processing applications configured for the system can run on the system concurrently, with a dynamically optimized number of parallel cores allocated per an application.
The allocation of the processing time across all the cores of the system among the application programs sharing the system is adaptive to the realtime processing loads of these applications.
There is inherent security and isolation between the individual processing applications in the system, as each application resides in its dedicated (logical) segment of the system memory, and can safely use the shared processing system effectively as if it was the sole application running on it. This hardware based security among the application programs and tasks sharing a multi-core data processing system per the invention further facilitates more straightforward, cost-efficient and faster development and testing of applications and tasks to run on such systems, as undesired interactions between the different user application programs and tasks can be disabled already at the system hardware level.

The invention thus enables maximizing the data processing throughput across all the processing applications configured to run on the shared multi-core computing system.

The hardware based scheduling and context switching of the invented system accordingly ensures that each application gets at least its entitled time share of the shared processing system capacity whenever any given processing application actually is able to utilize at least its entitled quota of system capacity, and as much processing capacity beyond its entitled quota as is possible without blocking the access to the entitled and fair share of the processing capacity by any other processing application that is actually able at that time to utilize such capacity that it is entitled to. The invention thus enables any given user application to get access to the full processing capacity of the multi-core system whenever the given application is the sole application offering processing load for the shared multi-core system. In effect, the invention provides for each user application assured access to its contract based percentage (e.g. 10%) of the multi-core system throughput capacity, plus most of the time much greater share, even 100%, of the processing system throughput capacity, with the cost base for any given user application being largely defined by only its committed access percentage worth of the shared multi-core processing system costs.

### CONCLUSIONS

This description and drawings are included to illustrate the architecture and operation of practical embodiments of the invention, but are not meant to limit the scope of the invention. For instance, even though the description does specify certain system parameters to certain types and values, persons of skill in the art will realize, in view of this description, that any design utilizing the architectural or operational principles of the disclosed systems and methods, with any set of practical types and values for the system parameters, is within the scope of the invention. For instance., in view of this description, persons of skill in the art will understand that the disclosed architecture sets no actual limit for the number of cores in a given system, or for the maximum number of applications or tasks to execute concurrently. Moreover, the system elements and process steps, though shown as distinct to clarify the illustration and the description, can in various embodiments be merged or combined wither other elements, or further subdivided and rearranged, etc., without departing from the spirit and scope of the invention. It will also be obvious to implement the systems and methods disclosed herein using various combinations of software and hardware. Finally, persons of skill in the art will realize that various embodiments of the invention can use different nomenclature and terminology to describe the system elements, process phases etc. technical concepts in their respective implementations. Generally, from this description many variants will be understood by one skilled in the art that are yet encompassed by the spirit and scope of the invention.

What is claimed is:

1. An application program load adaptive data processing system comprising:
an array of processing cores for processing instructions and data of a set of software application programs configured to share the system; and
a placer for repeatedly assigning individual cores of the array to individual application programs among said set,
wherein the assigning by the placer is done at least in part based on indicators, by at least some among the set of application programs, expressing how many cores of the array a given program is presently demanding.

2. The system of claim 1, wherein the placer is implemented in hardware logic.

3. The system of claim 1, wherein at least one of the indicators comprises a software variable mapped to a hardware device register within a memory space of at least one core of the array, with said device register being accessible by the placer.

4. The system of claim 1, wherein at least one of the indicators comprise a number indicating a quantity of cores within the array that its associated application program is currently able to execute on.

5. The system of claim 1, wherein:
the set of application programs are identifiable by program ID numbers from 0 through a total count of the programs configured to share the system less one; and
the assigning by the placer involves production of a program ID indexed digital look-up-table (LUT) within hardware logic of the system, with at least one given program ID indexed element of the LUT storing a number expressing how many cores of the array are being allocated to an application program associated with that given program ID indexed element of the LUT.

6. The system of claim 1, wherein:
the cores of the array are identifiable by core ID numbers from 0 through a total count of the cores of the array less one; and
the assigning by the placer involves production of a core ID indexed digital look-up-table (LUT) within hardware logic of the system, with at least one given core ID indexed element of the LUT storing an identifier of an application program assigned to the execute on a core associated with that given core ID indexed element of the LUT.

7. A process for executing application programs in a digital data processing system comprising an array of processing cores, the process comprising:
maintaining, by at least one program among a set of software application programs configured to share the system, at a specified address within a memory space of a core among said array a capacity demand indicator;
repeatedly allocating the array of cores among the set of programs at least in part based on the capacity demand indicator of at least one of the set of programs; and
processing instructions and data of the set of programs to produce processing outputs, wherein which program of the set is assigned for processing by which core or cores of the array is determined at least in part based on the allocating of the array of cores.

8. The process of claim 7, wherein the allocating of the array of cores among the set of programs is done with an objective of maximizing an instructions processing throughput of the system.

9. The process of claim 7, wherein the allocating of the array of cores is done in a manner that maximizes an instruction processing throughput of the system, while ensuring that any given program among the set of programs gets allocated at least its entitled share of cores within the array following any such exercising of the allocating step for which the given program was indicated as being able to execute in parallel on at least at such entitled share of the cores.

10. The process of claim 7, wherein at least one capacity demand indicator expresses on how many cores of the array its associated program is currently able to execute in parallel.

11. The process of claim 7, wherein, as a result of the allocating step, a representation of an allocation of the array of cores among the set of programs is stored in a program ID addressed digital hardware logic look-up-table (LUT), with entries at successive addresses of the LUT expressing a quantity of the processing cores being allocated to a program corresponding to a given address of the LUT.

12. The process of claim 7, wherein the step of allocating leads to producing a processing core ID indexed digital hardware logic look-up-table storing identifiers indicating to which program among the set a given core among the array was assigned to execute.

13. The process of claim 7, wherein the allocating is performed periodically, once in a specified time period.

14. The process of claim 7, wherein the allocating is performed following a change in a capacity demand indicator of at least one program among the set of application programs.

15. An algorithm for mapping, by a placer implemented in digital hardware logic, a set of software application programs to execute on an array of processing cores of a shared data processing hardware, the algorithm comprising a repeatedly exercised series of steps as follows:
monitoring capacity demand indicators of one or more programs among the set of application programs, with said indicator of given program expressing on how many cores among the array of cores the given program is a currently able to execute;
allocating the array of cores among the set of programs at least in part based on said capacity demand indicators; and
controlling which program among the set will execute on which core among the array at least in part based on said allocating.

16. The algorithm of claim 15, wherein the step of allocating the array of cores is done with an objective of reducing a greatest amount of unmet demands for cores among the set of application programs.

17. The algorithm of claim 15, wherein the step of allocating the array of cores is done with an objective of reducing a greatest amount of unmet demands among the set of programs, while ensuring that any given program gets at least its entitled share of the processing cores following such runs of the algorithm for which it demanded at least such entitled share.

18. The algorithm of claim 17, wherein the entitled share of processing cores for a given program is one of: i) an even division of amount of the cores within the array of cores, or ii) a contract based amount of cores.

19. The algorithm of claim 15, wherein the step of allocating the processing cores is done so that:
(i) initially, any actually materialized processing core demands by any programs up to their entitled share of cores within the array are met, and
(ii) following step (i), any processing cores that remain unallocated are allocated, in an iterative manner of allocating one core per program at a time, among the programs whose demand for processing cores had not been met by amounts of processing cores so far allocated to them by a present exercising of the algorithm (ii); and
(iii) following step (iii), any processing cores that remain unallocated are allocated among the application programs.

20. The algorithm of claim 15, wherein the step of allocating the array of cores among the set of application programs produces sequences of application program identifiers stored in a hardware logic digital look-up-table (LUT), with the application program identifiers stored in successive addresses of the LUT directing which application program will run on which processing core.

21. A method for assigning processing cores allocated among set of software application programs in a data processing system comprising an array of processing cores, with each program of the set having its home-core within the array, and with a core of the array not yet assigned to a program referred to as an available core, the method comprising a following series of steps:
(i) the home-core is assigned to its associated program for each program of the set having at least one allocated core;
(ii) following step (i), iterating through the set of programs, for each given program, until a number of cores assigned to the given program has reached either (a) a number of cores allocated to the given program or (b) entitled quota of cores for the given program, available cores closest to the home-core of the given program are assigned to that given program; and
(iii) following exercising of step (ii) for the set of programs, iterating through the set of programs, for each given program, until a number of cores assigned to the given program has reached the number of cores allocated to the given program, available cores closest to the home-core of the program are assigned to that given program.

22. The method of claim 21 such that is executed repeatedly, once each time after cores of the array are allocated anew among the set of programs.

23. The method of claim 22, wherein at least one of steps (i) and (ii) are exercised by iterating through the programs while starting with a revolving program within said set on successive executions of the method.

24. A method for placing processing tasks of a set of software application programs into processing cores of a data processing system comprising an array of processing cores, with each given program among the set (a) having a number of selected tasks equal to a number of cores of the array allocated to the given program and (b) presenting its selected tasks as a priority ordered list, with a selected task already placed to a core of the array referred to as a placed task and a selected task not yet placed to a core of the array referred to as an unplaced task, and with a core of the array not yet having a selected task placed to it referred to as an available core, the method comprising a following series of steps:
(i) a highest priority selected task of each given program is placed to a home-core of its program within the array of cores;
(ii) following step (i), iterating through the set of programs, any unplaced tasks of a given program, until a number of placed tasks for the given program would exceed an entitled quota of cores for the given program, are placed in their reducing priority order to available cores within the array closest to the home-core of the given program; and
(iii) following exercising of step (ii) for the set of programs, iterating through the set of programs, any remaining unplaced tasks of a given program are placed in their reducing priority order to available cores within the array closest to the home-core of the given program.

25. The method of claim 25, executed repeatedly, once after each time that cores of the array are reallocated among the set of programs, wherein at least one of steps (i) and (ii) are exercised by iterating through the programs while starting with a revolving program within said set on successive executions of the method.
